(19) United States
(12) Patent Application Publication
(10) Pub. No.: US 2023/0292261 A1
(43) Pub. Date: Sep. 14, 2023

(54) TRANSMIT POWER CONTROL INDICATION FOR MULTI-PANEL TRANSMISSION

(71) Applicants: Fang YUAN, San Diego, CA (US); Mahmoud TAHERZADEH BOROUJENI, San Diego, CA (US); Mostafa KHOSHNEVISAN, San Diego, CA (US); Jelena DAMNJANOVIC, San Diego, CA (US); Wooseok NAM, San Diego, CA (US); Tao LUO, San Diego, CA (US); Xiaoxia ZHANG, San Diego, CA (US); Juan MONTOJO, San Diego, CA (US); QUALCOMM INCORPORATED, San Diego, CA (US)

(72) Inventors: Fang YUAN, San Diego, CA (US); Mahmoud TAHERZADEH BOROUJENI, San Diego, CA (US); Mostafa KHOSHNEVISAN, San Diego, CA (US); Jelena DAMNJANOVIC, Del Mar, CA (US); Wooseok NAM, San Diego, CA (US); Tao LUO, San Diego, CA (US); Xiaoxia ZHANG, San Diego, CA (US); Juan MONTOJO, San Diego, CA (US)

(21) Appl. No.: 18/003,707

(22) PCT Filed: Aug. 25, 2020
(86) PCT No.: PCT/CN2020/110989

§ 371 Date: Dec. 29, 2022

(51) Int. Cl. H04W 52/42; H04W 52/22

(52) U.S. Cl. CPC H04W 52/42; H04W 52/226

(57) ABSTRACT

Methods, systems, and devices for wireless communications are described. A user equipment (UE) may communicate with a base station as part of a wireless communications system. The UE may receive, from a base station, an indication of a configuration for a multi-panel transmission power control (TPC) command to be transmitted by the base station. The UE may also receive, according to the indicated configuration, a downlink control information (DCI) message including a set of TPC commands. The UE may determine, based on the set of TPC commands, a first transmit power for a first antenna panel of the UE and a second transmit power for a second antenna panel of the UE. The UE may transmit an uplink signal using the first antenna panel at the first transmit power and the second antenna panel at the second transmit power.

### CROSS REFERENCE

The present application is a 371 national stage filing of International PCT Application No. PCT/CN2020/110989 by YUAN et al. entitled “TRANSMIT POWER CONTROL INDICATION FOR MULTI-PANEL TRANSMISSION,” filed Aug. 25, 2020, which is assigned to the assignee hereof, and which is expressly incorporated by reference in its entirety herein.

### FIELD OF TECHNOLOGY

The following relates to wireless communications, including transmit power control (TPC) indication for multi-panel transmission.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal frequency division multiple access (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

A UE may have multiple antenna panels that the UE may use to communicate with other devices, including base stations. A base station may control the transmission power for each antenna panel separately using a transmit power control (TPC) command. In order to determine the TPC command for each panel, the UE receives separate DCI messages for each panel, where each DCI message indicates the TPC for one panel. The TPC command may indicate a transmit power for each antenna panel.

### SUMMARY

The described techniques relate to improved methods, systems, devices, and apparatuses that support transmit power control (TPC) indication for multi-panel transmission. Generally, the described techniques provide for a user equipment (UE) communicating with a base station based on a TPC configuration indication and a set of TPC commands, indicating a transmission power change for one or more antenna panels of the UE. The UE may receive, from a base station, an indication of a configuration for a multi-panel TPC command to be transmitted by the base station. The UE may also receive, according to the indicated configuration (e.g., with a downlink control information (DCI) structure or format as provided by the indicated configuration), a DCI message including a set of TPC commands. The UE may determine, based on the set of TPC commands, a first transmit power for a first antenna panel of the UE and a second transmit power for a second antenna panel of the UE. The UE may transmit an uplink signal using the first antenna panel at the first transmit power and the second antenna panel at the second transmit power.

A method of wireless communications at a UE is described. The method may include receiving, from a base station, an indication of a configuration for a multi-panel TPC command to be transmitted by the base station, receiving, according to the indicated configuration, a DCI message including a set of TPC commands, determining, based on the set of TPC commands, a first transmit power for a first antenna panel of the UE and a second transmit power for a second antenna panel of the UE, and transmitting an uplink signal using the first antenna panel at the first transmit power and the second antenna panel at the second transmit power.

An apparatus for wireless communications at a UE is described. The apparatus may include a processor, memory coupled with the processor, and instructions stored in the memory. The instructions may be executable by the processor to cause the apparatus to receive, from a base station, an indication of a configuration for a multi-panel TPC command to be transmitted by the base station, receive, according to the indicated configuration, a DCI message including a set of TPC commands, determine, based on the set of TPC commands, a first transmit power for a first antenna panel of the UE and a second transmit power for a second antenna panel of the UE, and transmit an uplink signal using the first antenna panel at the first transmit power and the second antenna panel at the second transmit power.

Another apparatus for wireless communications at a UE is described. The apparatus may include means for receiving, from a base station, an indication of a configuration for a multi-panel TPC command to be transmitted by the base station, receiving, according to the indicated configuration, a DCI message including a set of TPC commands, determining, based on the set of TPC commands, a first transmit power for a first antenna panel of the UE and a second transmit power for a second antenna panel of the UE, and transmitting an uplink signal using the first antenna panel at the first transmit power and the second antenna panel at the second transmit power.

A non-transitory computer-readable medium storing code for wireless communications at a UE is described. The code may include instructions executable by a processor to receive, from a base station, an indication of a configuration for a multi-panel TPC command to be transmitted by the base station, receive, according to the indicated configuration, a DCI message including a set of TPC commands, determine, based on the set of TPC commands, a first transmit power for a first antenna panel of the UE and a second transmit power for a second antenna panel of the UE, and transmit an uplink signal using the first antenna panel at the first transmit power and the second antenna panel at the second transmit power.

Some examples of the method, apparatuses, and non-transitory computer-readable medium described herein may further include operations, features, means, or instructions for determining, based on the received indication, that the configuration for the multi-panel TPC command indicates that the DCI message includes a first TPC command and a second TPC command, where the first TPC command may be different from the second TPC command.

Some examples of the method, apparatuses, and non-transitory computer-readable medium described herein may further include operations, features, means, or instructions for determining the first transmit power based on the first TPC command, and determining the second transmit power based on a second TPC command, where the second TPC value may be a differential value applied to the first TPC command.

In some examples of the method, apparatuses, and non-transitory computer-readable medium described herein, the first TPC command includes two bits the second TPC command includes one bit.

Some examples of the method, apparatuses, and non-transitory computer-readable medium described herein may further include operations, features, means, or instructions for determining, based on a first field of the DCI message, a table of one or more multi-panel TPC command tables, and determining the first TPC command and the second TPC command based on the table and a second field of the DCI message that indicates a corresponding entry of a set of entries of the table.

In some examples of the method, apparatuses, and non-transitory computer-readable medium described herein, the second field of the DCI message indicates a row of the table, where the row includes an indication of the first TPC command and the second TPC command.

Some examples of the method, apparatuses, and non-transitory computer-readable medium described herein may further include operations, features, means, or instructions for receiving RRC signaling configuring the one or more multi-panel TPC command tables.

Some examples of the method, apparatuses, and non-transitory computer-readable medium described herein may further include operations, features, means, or instructions for determining the one or more multi-panel TPC command tables based on a pre-configuration.

Some examples of the method, apparatuses, and non-transitory computer-readable medium described herein may further include operations, features, means, or instructions for determining, based on the received indication, that the configuration for the multi-panel TPC command indicates that the DCI message includes a first TPC command and a second TPC command, where the first TPC command may be a same value as the second TPC command.

In some examples of the method, apparatuses, and non-transitory computer-readable medium described herein, receiving the configuration may include operations, features, means, or instructions for receiving, from the base station, RRC signaling or a medium access control control element (MAC-CE) including the indication of the configuration.

In some examples of the method, apparatuses, and non-transitory computer-readable medium described herein, the DCI message includes the indication of the configuration.

A method of wireless communications at a base station is described. The method may include transmitting, to a UE, an indication of a configuration for a multi-panel TPC command to be transmitted by the base station, determining to adjust a transmit power of one or more of a first antenna panel or a second antenna panel of the UE served by the base station, and transmitting, according to the indicated configuration, a DCI message including a set of TPC commands that are based on the determined transmit power.

An apparatus for wireless communications at a base station is described. The apparatus may include a processor, memory coupled with the processor, and instructions stored in the memory. The instructions may be executable by the processor to cause the apparatus to transmit, to a UE, an indication of a configuration for a multi-panel TPC command to be transmitted by the base station, determine to adjust a transmit power of one or more of a first antenna panel or a second antenna panel of the UE served by the base station, and transmit, according to the indicated configuration, a DCI message including a set of TPC commands that are based on the determined transmit power.

Another apparatus for wireless communications at a base station is described. The apparatus may include means for transmitting, to a UE, an indication of a configuration for a multi-panel TPC command to be transmitted by the base station, determining to adjust a transmit power of one or more of a first antenna panel or a second antenna panel of the UE served by the base station, and transmitting, according to the indicated configuration, a DCI message including a set of TPC commands that are based on the determined transmit power.

A non-transitory computer-readable medium storing code for wireless communications at a base station is described. The code may include instructions executable by a processor to transmit, to a UE, an indication of a configuration for a multi-panel TPC command to be transmitted by the base station, determine to adjust a transmit power of one or more of a first antenna panel or a second antenna panel of the UE served by the base station, and transmit, according to the indicated configuration, a DCI message including a set of TPC commands that are based on the determined transmit power.

In some examples of the method, apparatuses, and non-transitory computer-readable medium described herein, a first TPC command of the set of TPC commands may be different from a second TPC command of the set of TPC commands, where the first TPC command may be for the first antenna panel and the second TPC command may be for the second antenna panel.

In some examples of the method, apparatuses, and non-transitory computer-readable medium described herein, the second TPC value may be a differential value applied to the first TPC command.

In some examples of the method, apparatuses, and non-transitory computer-readable medium described herein, the first TPC command includes two bits the second TPC command includes one bit.

In some examples of the method, apparatuses, and non-transitory computer-readable medium described herein, a first field of the DCI message indicates a table of one or more multi-panel TPC command tables and a second field of the DCI message indicates a corresponding entry of a set of entries of the table, the entry indicating a first TPC command and a second TPC command.

In some examples of the method, apparatuses, and non-transitory computer-readable medium described herein, the second field of the DCI message indicates a row of the table, where the row includes an indication of the first TPC command and the second TPC command.

Some examples of the method, apparatuses, and non-transitory computer-readable medium described herein may further include operations, features, means, or instructions for transmitting, to the UE, RRC signaling configuring the one or more multi-panel TPC command tables.

Some examples of the method, apparatuses, and non-transitory computer-readable medium described herein may further include operations, features, means, or instructions for transmitting RRC signaling or MAC-CE signaling including the indication of the configuration.

In some examples of the method, apparatuses, and non-transitory computer-readable medium described herein, the DCI message includes the indication of the configuration.

### BRIEF DESCRIPTION OF THE DRAWINGS

FIG. 1 illustrates an example of a system for wireless communications that supports transmit power control (TPC) indication for multi-panel transmission in accordance with aspects of the present disclosure.

FIG. 2 illustrates an example of a wireless communications system that supports TPC indication for multi-panel transmission in accordance with aspects of the present disclosure.

FIGS. 3A, 3B, and 3C illustrate example panel configurations that support TPC indication for multi-panel transmission in accordance with aspects of the present disclosure.

FIG. 4 illustrates an example of a downlink control signal block that supports TPC indication for multi-panel transmission in accordance with aspects of the present disclosure.

FIG. 5 illustrates an example of a process flow that supports TPC indication for multi-panel transmission in accordance with aspects of the present disclosure.

FIGS. 6 and 7 show block diagrams of devices that support TPC indication for multi-panel transmission in accordance with aspects of the present disclosure.

FIG. 8 shows a block diagram of a communications manager that supports TPC indication for multi-panel transmission in accordance with aspects of the present disclosure.

FIG. 9 shows a diagram of a system including a device that supports TPC indication for multi-panel transmission in accordance with aspects of the present disclosure.

FIGS. 10 and 11 show block diagrams of devices that support TPC indication for multi-panel transmission in accordance with aspects of the present disclosure.

FIG. 12 shows a block diagram of a communications manager that supports TPC indication for multi-panel transmission in accordance with aspects of the present disclosure.

FIG. 13 shows a diagram of a system including a device that supports TPC indication for multi-panel transmission in accordance with aspects of the present disclosure.

FIGS. 14 through 17 show flowcharts illustrating methods that support TPC indication for multi-panel transmission in accordance with aspects of the present disclosure.

### DETAILED DESCRIPTION

A user equipment (UE) may have multiple antenna panels, which the UE may use to communicate with other devices, including base stations. The UE may use the multiple antenna panels, each with different antenna elements, to transmit and receive signals. The UE may use a particular transmit power for each antenna panel.

The power used for transmission by a UE may be controlled by a base station serving the UE. For example, the base station may indicate one or more transmit power control (TPC) commands. Each TPC command may be used to incrementally increase or decrease the transmit power of the UE. Additionally, the base station may control the transmission power for each antenna panel separately using a TPC command.

In some cases, in order to determine the transmit power adjustments to the transmit power for each panel (e.g., incrementing the transmit power higher, lower, or staying the same value), the UE may receive separate downlink control information (DCI) messages for each antenna panel, where each DCI message indicates the TPC command for a respective one antenna panel. Thus, a base station may transmit multiple DCI messages to indicates TPC commands for multiple antenna panels of a UE, which may thereby use substantial overhead. Further, different panels may use different radio frequency (RF) chains, and the different RF chains may not be able to be controlled by the same TPC command. Thus, a base station may not be able to indicate a single TPC command in a single DCI that would apply to all antenna panels of the UE.

In order to avoid the overhead involved in receiving a separate DCI message for each panel, a base station may transmit and a UE may receive an indication of a multi-panel TPC configuration. The multi-panel TPC configuration may indicate that a DCI message is to include multiple TPC commands for different panels. For example, the multi-panel TPC configuration may indicate whether the UE may receive a single TPC command which may apply for all transmit panels of the UE, or whether the UE may determine the TPC commands for each panel based on one DCI message. Thus, the multi-panel TPC configuration may indicate a shared configuration, and in these cases the UE may use the same TPC commands across panels. The TPC configuration may also indicate a separate configuration, which may indicate that a separate TPC command should be used for each panel.

Based on the multi-panel TPC configuration indication, the base station may configure and the UE may interpret the DCI message indicating the TPC command. In one case, when the TPC configuration is indicated as a separate configuration, the base station may transmit and the UE may receive an indication of one TPC command in the DCI message, and the base station may configure and the UE determine a second TPC command based on a differential function of the first TPC command. In another case of separate TPC commands, there may be a set of TPC command tables. The DCI may indicate a table of a set of tables based on a TPC command field of the DCI, from which table the UE may determine a set of TPC commands from the selected table based on a second field of the DCI. For example, the UE may use the DCI TPC field and a logarithm function of the same TPC field to select a set of TPC commands from a table. The multi-panel TPC configuration may be indicated to the UE by radio resource control (RRC) signaling or medium access control control element (MAC-CE) signaling transmitted by the base station. In other cases, the DCI message including the TPC command may include the indication of the multi-panel TPC configuration.

Based on identifying the TPC command for each antenna panel (e.g., either a joint TPC command or separate TPC commands), the UE may change the transmission power for each antenna panel based on the respective TPC command for the panel. For example, the UE may increment the transmit power higher, lower, or maintain the same value for each antenna panel according to the respective TPC command for the panel determined from the DCI message. The UE may then transmit uplink signals using the updated transmission power for the antenna panel.

Aspects of the disclosure are initially described in the context of wireless communications systems. Aspects of the disclosure are then described with respect to panels configurations, a downlink control signal block, and a process flow. Aspects of the disclosure are further illustrated by and described with reference to apparatus diagrams, system diagrams, and flowcharts that relate to TPC indication for multi-panel transmission.

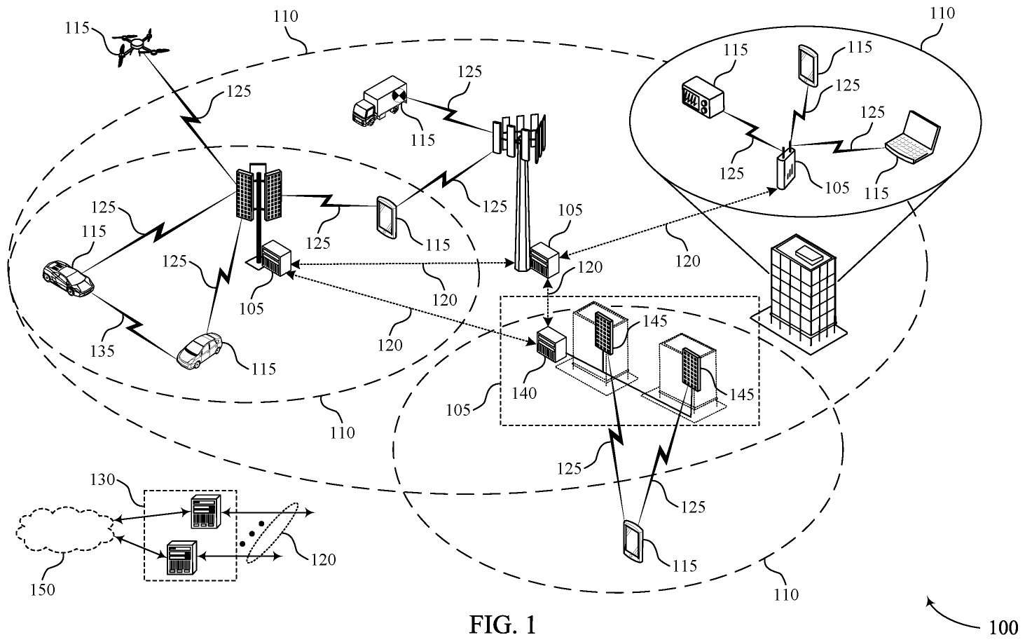

FIG. 1 illustrates an example of a wireless communications system 100 that supports TPC indication for multi-panel transmission in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable (e.g., mission critical) communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode where initial acquisition and connection may be conducted by the UEs 115 via the carrier, or the carrier may be operated in a non-standalone mode where a connection is anchored using a different carrier (e.g., of the same or a different radio access technology).

The communication links 125 shown in the wireless communications system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications (e.g., in a TDD mode).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of determined bandwidths for carriers of a particular radio access technology (e.g., 1.4, 3, 5, 10, 15, 20, 40, or 80 megahertz (MHz)). Devices of the wireless communications system 100 (e.g., the base stations 105, the UEs 115, or both) may have hardware configurations that support communications over a particular carrier bandwidth or may be configurable to support communications over one of a set of carrier bandwidths. In some examples, the wireless communications system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

Each base station 105 may provide communication coverage via one or more cells, for example a macro cell, a small cell, a hot spot, or other types of cells, or any combination thereof. The term “cell” may refer to a logical communication entity used for communication with a base station 105 (e.g., over a carrier) and may be associated with an identifier for distinguishing neighboring cells (e.g., a physical cell identifier (PCID), a virtual cell identifier (VCID), or others). In some examples, a cell may also refer to a geographic coverage area 110 or a portion of a geographic coverage area 110 (e.g., a sector) over which the logical communication entity operates. Such cells may range from smaller areas (e.g., a structure, a subset of structure) to larger areas depending on various factors such as the capabilities of the base station 105. For example, a cell may be or include a building, a subset of a building, or exterior spaces between or overlapping with geographic coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered base station 105, as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A base station 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may support synchronous or asynchronous operation. For synchronous operation, the base stations 105 may have similar frame timings, and transmissions from different base stations 105 may be approximately aligned in time. For asynchronous operation, the base stations 105 may have different frame timings, and transmissions from different base stations 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception simultaneously). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC) or mission critical communications. The UEs 115 may be designed to support ultra-reliable, low-latency, or critical functions (e.g., mission critical functions). Ultra-reliable communications may include private communication or group communication and may be supported by one or more mission critical services such as mission critical push-to-talk (MCPTT), mission critical video (MCVideo), or mission critical data (MCData). Support for mission critical functions may include prioritization of services, and mission critical services may be used for public safety or general commercial applications. The terms ultra-reliable, low-latency, mission critical, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

In some systems, the D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., base stations 105) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to the network operators IP services 150. The network operators IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the base stations 105, and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

The base stations 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, the base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the base station 105 in different directions and may report to the base station 105 an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). The UE 115 may report feedback that indicates precoding weights for one or more beam directions, and the feedback may correspond to a configured number of beams across a system bandwidth or one or more sub-bands. The base station 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the RRC protocol layer may provide establishment, configuration, and maintenance of an RRC connection between a UE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

A UE 115 may communicate with a base station 105 based on a TPC configuration indication and a set of TPC commands, indicating a transmission power change for one or more antenna panels of the UE 115. The UE 115 may receive, from a base station 105, an indication of a configuration for a multi-panel TPC command to be transmitted by the base station. The UE 115 may also receive, according to the indicated configuration, a DCI message including a set of TPC commands. The UE 115 may determine, based on the set of TPC commands, a first transmit power for a first antenna panel of the UE 115 and a second transmit power for a second antenna panel of the UE 115. The UE 115 may transmit an uplink signal using the first antenna panel at the first transmit power and the second antenna panel at the second transmit power.

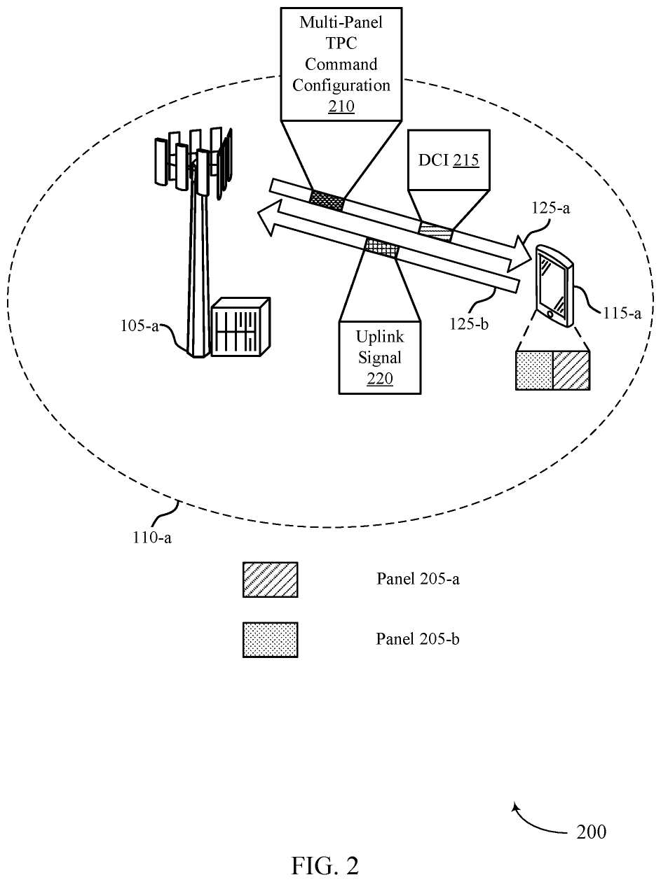

FIG. 2 illustrates an example of a wireless communications system 200 that supports TPC indication for multi-panel transmission in accordance with aspects of the present disclosure. In some examples, wireless communications system 200 may implement aspects of wireless communications system 100 and may include UE 115-a, downlink communication link 125-a, uplink communication link 125-b, and base station 105-a with coverage area 110-a, which may be examples of a UE 115, a communication link 125, and a base station 105 with a coverage area 110 as described with reference to FIG. 1. In some aspects, UE 115-a may be configured with, or otherwise support, multi-panel transmissions to and from base station 105-a using one or more panels 205. For example, UE 115-a and base station 105-a may communicate using panel 205-a, panel 205-b, or both, via communication link 125-a.

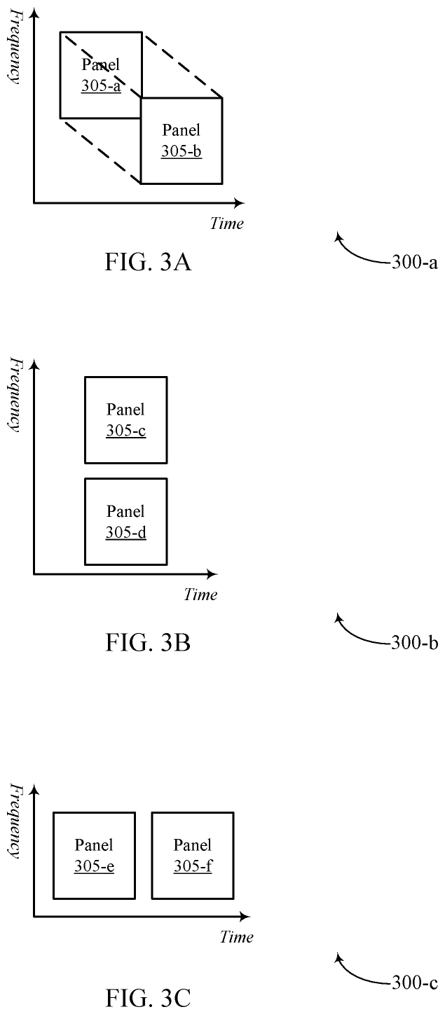

In some cases, a panel 205 of a UE 115 may refer to any configuration of hardware (e.g., antennas), software (e.g., beamforming techniques, directional transmission techniques, weighting criteria, etc.), or both, used to perform uplink transmission or downlink reception. In some examples, a panel 205 of the UE 115 may refer to different antennas of the UE 115, an antenna of the UE 115 using a different configuration for transmissions, or both. For example, a panel 205 may refer to a particular transmitted precoding matrix indicator (TPMI) configured for the UE 115, a sounding reference signal resource indicator (SRI) configured for the UE 115, a transmission configuration indicator (TCI) configured for the UE 115, or the like. When the UE 115 supports multiple panels 205, each panel 205 may be distinguished from other panels 205 using information, which may be included in a panel identification (ID) as described in further detail with reference to FIG. 3. In some cases, panels 205 of UE 115-a (e.g., panel 205-a and panel 205-b) used to perform a multi-panel transmission and reception may use various multiplexing techniques, such as space-division multiplexing (SDM), FDM, TDM, and the like. For example, a panel 205 of UE 115-a may be used for an uplink or downlink transmission corresponding to a spatial configuration of the SDM, a frequency of the FDM, a time period of the TDM.

UE 115-a may receive, from base station 105-a, multi-panel TPC command configuration 210. Multi-panel TPC command configuration 210 may indicate, to UE 115-a, whether a TPC command in control signaling (e.g., in DCI 215) is to be applied to all antenna panels 205 of UE 115-a, or whether the TPC command in DCI 215 indicates a separate TPC command for each antenna panel 205 of UE 115-a. Base station 105-a may transmit multi-panel TPC command configuration 210 in a RRC message, in MAC-CE signaling, or within DCI 215.

In a first case, UE 115-a may receive multi-panel TPC command configuration 210 indicated a separate TPC command configuration, thereby indicating that each antenna panel 205 of UE 115-a may be subject to a different TPC command. UE 115-a may receive DCI 215 including a TPC command indication. In one case, DCI 215 may include a first TPC command field, which may indicate a TPC command for a first antenna panel (e.g., panel 205-a). UE 115-a may identify a second TPC command based on a differential value applied to the first TPC command. For example, the first TPC command may be two bits (e.g., indicated in a field of DCI 215), and the second TPC command may be one bit. An example table of the first TPC command and the second TPC command is as follows:

TABLE 1
Example First TPC Command Table

| First TPC | Accumulated | Absolute |
|---|---|---|
| Command (bit value) | TPC (dB) | TPC (dB) |
| 00 | −1 | −4 |
| 01 | 0 | 1 |
| 10 | 1 | 1 |
| 11 | 3 | 4 |

TABLE 2
Example Second TPC Command Table

| Second TPC | Accumulated | Absolute |
|---|---|---|
| Command (bit value) | TPC (dB) | TPC (dB) |
| 0 | −1 | 2 |
| 1 | 0 | 0 |

Accumulated TPC may refer to a delta TPC, where the TPC command is a correction in regard to a previous TPC command of the antenna panel, for example denominated in dB. Absolute TPC may refer to a correction that is reset each time a new TPC command is received, for example also denominated in dB.

Thus, UE 115-a may identify the first TPC command, and apply the first TPC command to panel 205-a. UE 115-a may identify the second TPC command based on a differential value of the first TPC command, and may apply the second TPC command to panel 205-b.

In another case, UE 115-a may receive multi-panel TPC command configuration 210 indicated a separate TPC command configuration, thereby indicating that each antenna panel 205 of UE 115-a may be subject to a different TPC command. UE 115-a may receive DCI 215 including a TPC command indication. UE 115-a may apply a number of tables (e.g., N number of tables) to determine the first TPC command for panel 205-a and a second TPC command for panel 205-b. UE 115-a may identify a first TPC field of DCI 215. The first TPC field may be of a log₂ N (logarithm base 2 (N)) bits, where N is the number of tables. For example, if N is 1, the first TPC field of DCI 215 is of a zero bit, and the second TPC field of DCI 215 may be indicated (e.g., without the first TPC field of DCI 215). The first TPC field of DCI 215 may indicate which table of the set of tables that may be used for applying the multi-panel TPC commands. A second TPC field of DCI 215 may indicate a TPC command (e.g., indicating a pair of TPC commands) from the table indicated by the first TPC field of the DCI. The N number of tables may be preconfigured, or UE 115-a may receive RRC signaling indicating the number of tables, the contents of the TPC tables, or both. The tables may also be predetermined or preconfigured without RRC signaling.

For example, the first identified TPC field of DCI 215 may indicate the below table:

TABLE 3
TPC Command Table Example

| | First DCI 215 TPC Field (Accumulated TPC) | |
|---|---|---|
| Second DCI 215 TPC | Table A | Table B |
| Field (bit value) | (0) (dB) | (1) (dB) |
| 00 | −1, −1 | −1, 0 |
| 01 | 0, 0 | 1, 0 |
| 10 | 1, 1 | 0, 1 |
| 11 | 3, 3 | 0, −1 |

The second TPC field of DCI 215 may indicate a row of the table, which may include a pair of TPC commands, which may be applied to panel 205-a and 205-b, where the TPC commands are denominated in dB. For example, the first TPC field of the DCI 215 may indicate Table A (e.g., the first TPC field of the DCI 215 may be a one, and thus may indicate Table B). The second TPC field of the DCI 215 may be a set of bits “10”. Thus, the identified TPC command may be “1,0”. Therefore, a TPC command of 1 may be applied to the transmit power of panel 205-a, and a TPC command of 0 may be applied to the transmit power of panel 205-b. UE 115-a may therefore transmit uplink signal 220 using panels 205-a and 205-b, according to the adjusted transmit power.

FIG. 3 illustrates an example of panel configurations 300 that supports TPC indication for multi-panel transmission in accordance with aspects of the present disclosure. In some examples, panel configurations 300 may implement aspects of wireless communications system 100 or wireless communications system 200. Aspects of panel configurations 300 may be implemented by a UE 115, a base station 105, or both, as described with reference to FIGS. 1 and 2. For example, panel configuration 300-a through panel configuration 300-c may include panel 305-a through panel 305-f, which may be an example of a panel 205 as described with reference to FIG. 2. Generally, panel configuration 300-a of FIG. 3A illustrates an example of the described techniques applied in an SDM scenario, panel configuration 300-b of FIG. 3B illustrates an example of the described techniques applied in an FDM scenario, and transmit panel configuration 300-c of FIG. 3C illustrates an example of the described techniques applied in a TDM scenario.

In some cases, a UE 115 may support multi-panel communications with a base station 105 using panels 305 of the UE 115. Each panel 305 may be distinguished from other panels using information, such as a panel ID. A panel 305 may be associated with a set of downlink or uplink signals and channels, and correspondingly, the panel ID may be associated with the set of signal or channel IDs and indicated or derived by the signal or channel IDs. In one example, a control resource set (CORESET) may be configured with a CORESET pool index. A first panel 305 (e.g., panel 305-a, panel 305-c, panel 305-e, or a combination) may be associated with a DCI in a CORESET with a first CORESET pool index value (e.g., CORESET pool index 0) and a second panel 305 (e.g., panel 305-b, panel 305-d, panel 305-f, or a combination) may be associated with DCI in a CORESET with a second CORESET pool index value (e.g., CORESET pool index 1).

In another example, a sounding reference signal (SRS) set ID or SRS resource ID may be associated with panel 305-a, panel 305-c, panel 305-e, or the combination and another SRS set ID or SRS resource ID may be associated with panel 305-b, panel 305-d, panel 305-f, or the combination. Further, a beam ID or beam group ID may be associated with panel 305-a, panel 305-c, panel 305-e, or the combination and another beam ID or beam group ID may be associated with panel 305-b, panel 305-d, panel 305-f, or the combination. The beam may be a TCI state or a spatial filter setting for either downlink reception or uplink transmission and may be a spatial relation information indicated for transmitting uplink signals. The beam may be indicated by a reference signal (RS) such as a synchronization signal block (SSB), channel-state-information (CSI) RS or SRS. When a group of beam IDs are configured, the first half of the group of beam IDs may be associated with panel 305-a, panel 305-c, panel 305-e, or the combination, and the second half group of the group of beam IDs may be associated with panel 305-b, panel 305-d, panel 305-f, or the combination.

When a pair of TCI states are indicated, the first TCI state ID in the pair may be associated with panel 305-a, panel 305-c, panel 305-e, or the combination, and the second TCI state ID in the pair may be associated with panel 305-b, panel 305-d, panel 305-f, or the combination. An uplink TPC configuration may include a closed loop index, and an uplink transmission with a first closed loop index value (e.g., 0) may be associated with panel 305-a, panel 305-c, panel 305-e, or the combination and another uplink transmission with a second closed loop index value (e.g., 1) may be associated with panel 305-b, panel 305-d, panel 305-f, or the combination.

An antenna port ID or antenna port group ID may be associated with panel 305-a, panel 305-c, panel 305-e, or the combination, and another antenna port ID or antenna port group ID may be associated with panel 305-b, panel 305-d, panel 305-f, or the combination, where the antenna port may include, but is not limited to, a physical uplink shared channel (PUSCH) antenna port, an SRS antenna port, or a phase-tracking RS antenna port. A DMRS code division multiplexing (CDM) group ID may be associated with panel 305-a, panel 305-c, panel 305-e, or the combination, and another DMRS CDM group ID may be associated with panel 305-b, panel 305-d, panel 305-f, or the combination. When multiple DMRS CDM groups are indicated, the first DMRS CDM group may be associated with panel 305-a, panel 305-c, panel 305-e, or the combination, and the second DMRS CDM group may be associated with panel 305-b, panel 305-d, panel 305-f, or the combination.

A timing advance group (TAG) ID may be associated with panel 305-aaaa, panel 305-c, panel 305-e, or the combination, and another TAG ID may be associated with panel 305-b, panel 305-d, panel 305-f, or the combination. A physical uplink control channel (PUCCH) resource ID or resource group ID may be associated with panel 305-a, panel 305-c, panel 305-e, or the combination, and another PUCCH resource ID or resource group ID may be associated with panel 305-b, panel 305-d, panel 305-f, or the combination. When a group of PUCCH resource IDs are configured, the first half group of the PUCCH resource IDs may be associated with panel 305-b, panel 305-d, panel 305-f, or the combination, and the second half group of PUCCH resource IDs may be associated with panel 305-b, panel 305-d, panel 305-f, or the combination. A radio network temporary identifier (RNTI) may be associated with panel 305-a, panel 305-c, panel 305-e, or the combination, and another RNTI may be associated with panel 305-b, panel 305-d, panel 305-f, or the combination. A physical cell identity (PCI) or synchronization signal block (SSB) set ID may be associated with panel 305-a, panel 305-c, panel 305-e, or the combination, and another PCI or SSB set ID may be associated with panel 305-b, panel 305-d, panel 305-f, or the combination. By referring to or otherwise indicating the signal or channel IDs, the corresponding panel ID can be referred or indicated (e.g., implicitly signaled in the configuration signal).

As discussed herein, a UE 115 may support multi-panel uplink transmissions to a base station 105 using panels 305 of the UE 115, such as a panel 305-a through panel 305-f. Generally, a panel 305 of the UE 115 may refer to any configuration of hardware (e.g., antennas), software (e.g., beamforming techniques, directional transmission techniques, weighting criteria, etc.), or both, used to perform an uplink transmission or downlink reception. In some examples, a panel 305 of the UE 115 may refer to different antennas of the UE 115, to an antenna of the UE 115 using different configurations for transmissions, or both. In some example, multiple panels 305 of the UE 115 may be used to perform a multi-panel uplink transmission using various multiplexing techniques, such as SDM, FDM, TDM, a combination of two or more of SDM, FDM, and TDM, and the like. As illustrated in FIG. 3A, panel 305-a and panel 305-b of the UE 115 may be used for a transmission on a spatial configuration of the SDM. As illustrated in FIG. 3B, panel 305-c and panel 305-d of the UE 115 may be used for a transmission on a frequency of the FDM. As illustrated in FIG. 3C, panel 305-e and panel 305-f of the UE 115 may be used for a transmission during a time of the TDM. In some aspects, a panel 305 may refer to a special panel ID (e.g., a lower panel ID), with a special CORESET pool index (e.g., a lower CORESET pool index), with a special SRS ID (e.g., a lower SRS set index), with a special close loop index (e.g., a lower closed loop index), and the like.

In some cases, the UE 115 may receive an indication of a TPC command configuration, where the UE 115 may identify a TPC command to apply to panels 305 of the UE 115. The UE 115 may perform multi-panel communications (e.g., with any combination of panel 305-a through panel 305-f) after applying a TPC command to each panel 305 of the UE 115. The UE 115 may receive, from a base station 105, an indication of a multi-panel TPC configuration, which may indicate multiple TPC commands for different panels 305 of the UE 115. The multi-panel TPC configuration may indicate whether the UE 115 may receive a single TPC command which may apply for all panels 305 of the UE, or whether the UE 115 may determine the TPC commands for each panel based on one DCI. Thus, the multi-panel TPC configuration may indicate a shared configuration, and in these cases the UE 115 may use the same TPC commands across panels 305. For example, the UE 115 may determine to use the same TPC command for panel 305-c and 305-d The TPC configuration may also indicate a separate configuration, which may indicate that a separate TPC command should be used for each panel. For example, the UE 115 may apply a first TPC command to panel 305-c, and a second TPC command to panel 305-d.

With reference to transmit panel configuration 300-a of FIG. 3A, the multi-panel communications may utilize SDM techniques such that a first transmission using panel 305-a is transmitted or received using a first spatial configuration. A second transmission using panel 305-b may be transmitted using a second spatial configuration that is different from the first spatial configuration. For example, the first spatial configuration may use different beamforming configurations for the first transmission than the second spatial configuration uses for the second transmission. Thus, the UE 115 may transmit or receive the first transmission using panel 305-a at the same time (e.g., in parallel) and using the same frequency resources for transmitting or receiving the second transmission using panel 305-b.

With reference to transmit panel configuration 300-b of FIG. 3B, the multi-panel communications may utilize FDM techniques such that the first transmission using panel 305-c is transmitted or received using a first frequency. The second transmission using panel 305-d may be transmitted or received using a second frequency that is different from the first frequency. For example, the first frequency and the second frequency may have different subcarriers, carriers, bandwidth, bandwidth parts (BWPs), and the like, being used for the first transmission and the second transmission. Thus, the UE 115 may transmit or receive the first transmission using panel 305-c at the same time (e.g., in parallel), but using different frequency resources for transmitting or receiving the second transmission using panel 305-d.

With reference to transmit panel configuration 300-c of FIG. 3C, the multi-panel communications may utilize TDM techniques such that the first transmission using 305-e is transmitted or received at a first time period. The second transmission using panel 305-f may be transmitted or received at a second time period that is different from the first time period. For example, the first time period and the second time period may have different symbols, mini-slots, slots, transmission opportunities, transmission occasions, and the like, being used for the first transmission and the second transmission. Thus, the UE 115 may transmit or receive the first transmission using panel 305-e at a different time (e.g., consecutively), but using the same frequency resources for transmitting or receiving the second transmission using panel 305-f.

Accordingly, the UE 115 may perform the multi-panel communications with the base station 105 using panels 305 according to slot formats for each panel. The UE 115, the base station 105, or both, may transmit or receive and process a multi-panel transmission according to the techniques discussed herein (e.g., according to the TPC command configuration received from a base station 105). The multi-panel communications may utilize SDM techniques, FDM techniques, TDM techniques, alone or in any combination (i.e., SDM and FDM, FDM and TDM, SDM and TDM, or SDM, FDM, and TDM).

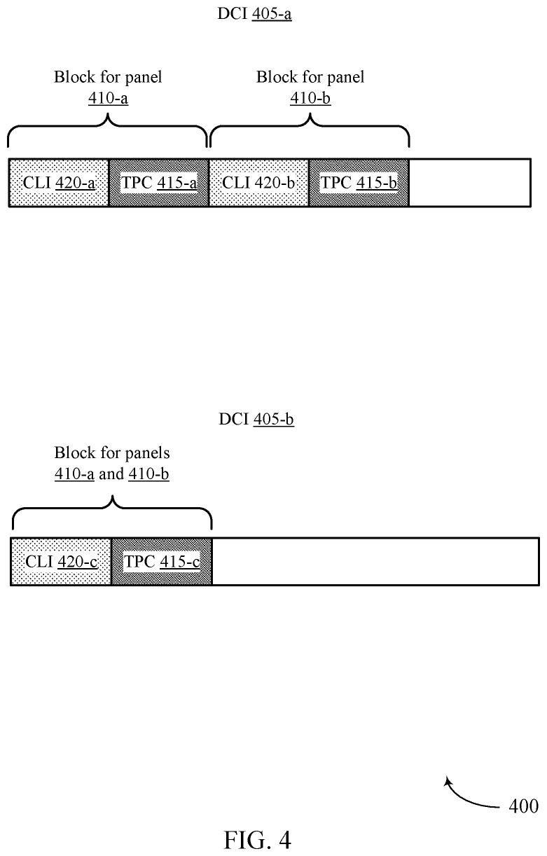

FIG. 4 illustrates an example of a downlink control signal block 400 that supports TPC indication for multi-panel transmission in accordance with aspects of the present disclosure. In some examples, downlink control signal block 400 may implement aspects of wireless communications system 100 or wireless communications system 200. Aspects of downlink control signal block 400 may be implemented by a UE 115, a base station 105, or both, as described with reference to FIGS. 1, 2, and 3.

A UE 115 may receive, from a base station 105, a UE 115 may receive signaling indicating a configuration or format of a DCI will carry TPC commands for the UE 115 that has multiple panels, for example a multi-panel TPC command configuration. The configuration may indicate a shared or separate TPC command configuration. A shared configuration includes the case where the UE 115 applies the same TPC command to multiple panels 410 of the UE 115, and a separate configuration includes the case where a UE 115 applies different TPC commands to each panel 410 of the UE 115. The TPC commands may adjust the transmit power of the panels 410 of the UE 115, and the UE 115 may transmit an uplink control signal using the panels 410 of the UE 115, according to the updated transmit power. For example, a UE 115 may have a first panel 410-a and a second panel 410-b.

After receiving the indication of the TPC command configuration, UE 115 may receive a DCI 405 that includes blocks of bits (e.g., fields) indicating TPC commands. In some cases, the DCI 405 may include the indication of the multi-panel TPC command configuration. In the case of a separate TPC command configuration, the UE 115 may receive DCI 405-a having separate TPC commands. DCI 405-a may include a first block for first panel 410-a. The first block may include an indication of a closed loop indication (CLI) 420-a for panel 410-a, and an indication of TPC 415-a. In some cases, the CLI may be disabled by RRC signaling, for example from a base station 105. DCI 405-a may also include a block for panel 410-b (e.g., second TPC field), including a CLI 420-b for panel 410-b, and a TPC 415-b for panel 410-b. The UE 115 may determine the TPC command for each panel 410 according to the configuration described with respect to FIG. 2 (e.g., determining a second TPC command based on second TPC 415-b command bits and a differential value applied to the first TPC 415-a command bits, or based on a set of TPC command tables that are identified based on TPC 415-a and 415-b)

In another case, the UE 115 may receive a multi-panel TPC command configuration indicating a shared TPC command configuration. The UE 115 may receive DCI 405-b, which may include a block for both panels 410-a and 410-b (e.g., a single TPC field for the multiple panels). The block may include an indication of a CLI 420-c and an indication of TPC 415-c. TPC 415-c may apply to both panels 410-a and 410-b. The UE 115 may apply the TPC 415-c command to both panel 410-a and 410-b, and the UE 115 may transmit an uplink signal to the base station 105 according to the updated transmit power.

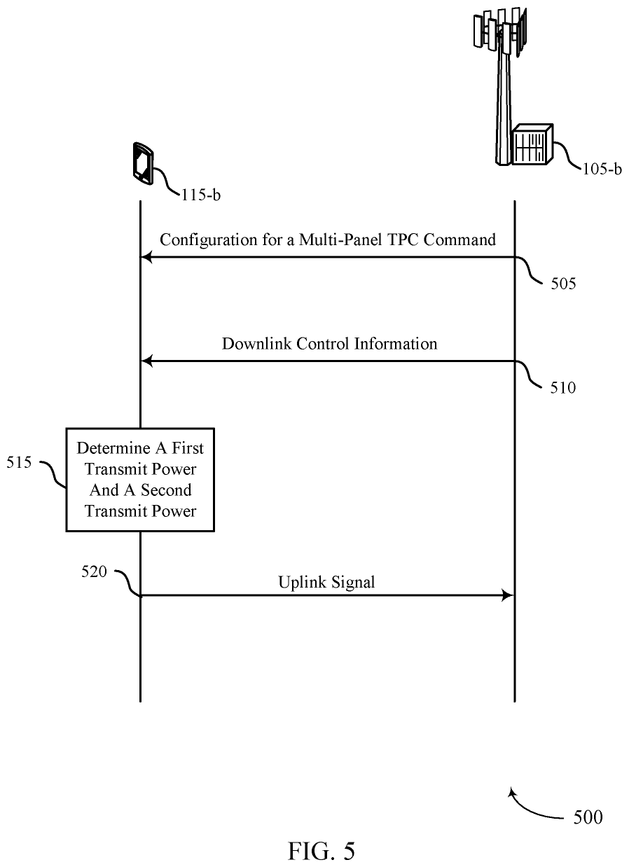

FIG. 5 illustrates an example of a process flow 500 that supports TPC indication for multi-panel transmission in accordance with aspects of the present disclosure. In some examples, process flow 500 may implement aspects of wireless communication systems 100 and 200. Process flow 500 includes UE 115-b, which may be an example of a UE 115 as described with respect to FIGS. 1-4. Process flow 500 also includes base station 105-b, which may be an example of a base station 105 as described with respect to FIGS. 1-4.

At 505, UE 115-b may receive, from base station 105-b, an indication of a configuration for a multi-panel TPC command to be transmitted by base station 105-b. In some cases, base station 105-b may transmit the indication of the configuration via RRC signaling or a MAC-CE. In other cases, the configuration for the multi-panel TPC command may be included in the DCI transmitted at 510. UE 115-b may determine, based on the received indication, that the configuration for the multi-panel TPC command indicates that the DCI message includes a first TPC command and a second TPC command. In some cases, the first TPC command is different from the second TPC command. In other cases, the first TPC command is a same value as the second TPC command.

At 510, UE 115-b, may receive, according to the indicated configuration, a DCI message including a set of TPC commands.

In some cases, UE 115-b may determine, based on a first field of the DCI message, a table of one or more multi-panel TPC commands. The UE 115-b may determine the first TPC command and the second TPC command based on the table and a second field of the DCI message that indicates a corresponding entry of a set of entries of the table. The second field of the DCI message may indicate a row of the table, where the row includes an indication of the first TPC command and the second TPC command. In some cases, UE 115-b may receive RRC signaling configuring the one or more multi-panel TPC command tables. In other cases, UE 115-b may determine the one or more multi-panel TPC command tables based on a pre-configuration.

At 515, UE 115-b may determine, based on the set of TPC commands, a first transmit power for a first antenna panel of UE 115-b and a second transmit power for a second antenna panel of UE 115-b.

In some cases where the first TPC command is different from the second TPC command, UE 115-b may determine the first transmit power based on the first TPC command, and may determine the second transmit power based on a second TPC command, where the second TPC value is a differential value applied to the first TPC command. The first TPC command may be two bits and the second TPC command may be one bit.

At 520, UE 115-b may transmit an uplink signal using the first antenna panel at the first transmit power and the second antenna panel at the second transmit power.

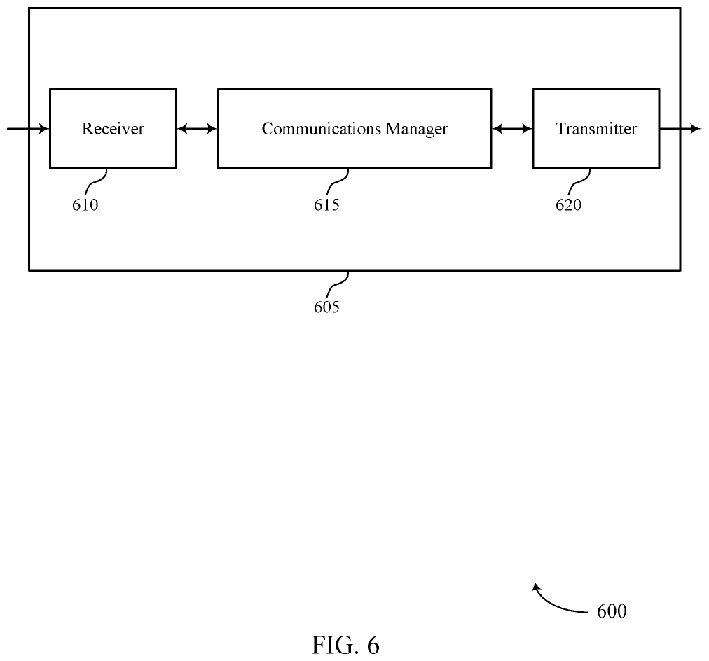

FIG. 6 shows a block diagram 600 of a device 605 that supports TPC indication for multi-panel transmission in accordance with aspects of the present disclosure. The device 605 may be an example of aspects of a UE 115 as described herein. The device 605 may include a receiver 610, a communications manager 615, and a transmitter 620. The device 605 may also include a processor. Each of these components may be in communication with one another (e.g., via one or more buses).

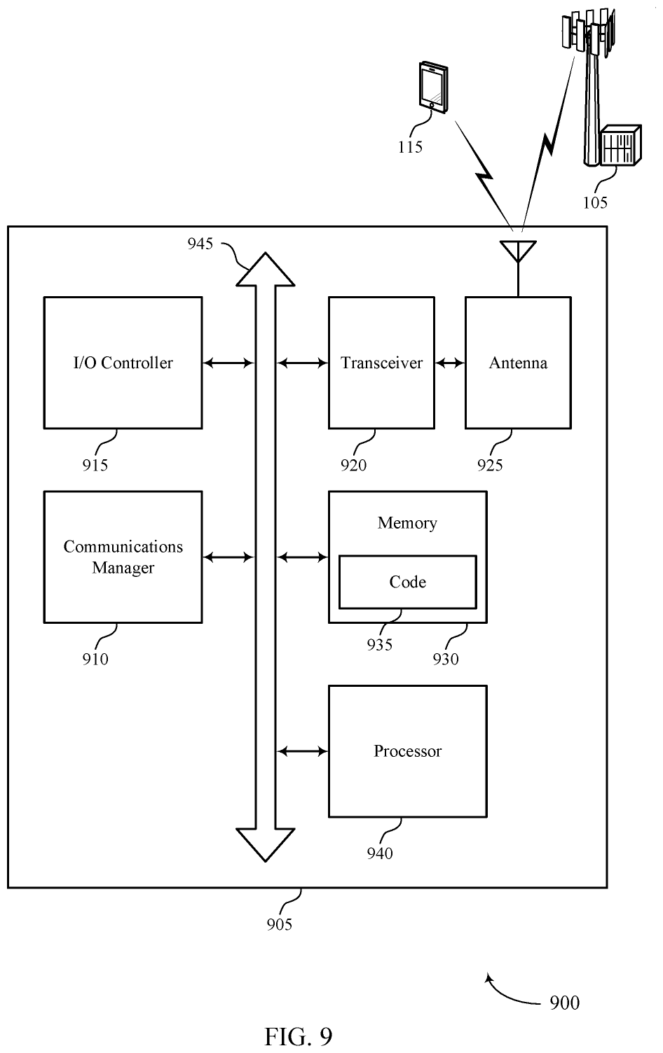

The receiver 610 may receive information such as packets, user data, or control information associated with various information channels (e.g., control channels, data channels, and information related to TPC indication for multi-panel transmission, etc.). Information may be passed on to other components of the device 605. The receiver 610 may be an example of aspects of the transceiver 920 described with reference to FIG. 9. The receiver 610 may utilize a single antenna or a set of antennas.

The communications manager 615 may receive, from a base station, an indication of a configuration for a multi-panel transmission power control command to be transmitted by the base station, receive, according to the indicated configuration, a DCI message including a set of transmission power control commands, determine, based on the set of transmission power control commands, a first transmit power for a first antenna panel of the UE and a second transmit power for a second antenna panel of the UE, and transmit an uplink signal using the first antenna panel at the first transmit power and the second antenna panel at the second transmit power. The communications manager 615 may be an example of aspects of the communications manager 910 described herein.

The communications manager 615, or its sub-components, may be implemented in hardware, code (e.g., software or firmware) executed by a processor, or any combination thereof. If implemented in code executed by a processor, the functions of the communications manager 615, or its sub-components may be executed by a general-purpose processor, a digital signal processor (DSP), an application-specific integrated circuit (ASIC), a field-programmable gate array (FPGA) or other programmable logic device, discrete gate or transistor logic, discrete hardware components, or any combination thereof designed to perform the functions described in the present disclosure.

The communications manager 615, or its sub-components, may be physically located at various positions, including being distributed such that portions of functions are implemented at different physical locations by one or more physical components. In some examples, the communications manager 615, or its sub-components, may be a separate and distinct component in accordance with various aspects of the present disclosure. In some examples, the communications manager 615, or its sub-components, may be combined with one or more other hardware components, including but not limited to an input/output (I/O) component, a transceiver, a network server, another computing device, one or more other components described in the present disclosure, or a combination thereof in accordance with various aspects of the present disclosure.

The transmitter 620 may transmit signals generated by other components of the device 605. In some examples, the transmitter 620 may be collocated with a receiver 610 in a transceiver module. For example, the transmitter 620 may be an example of aspects of the transceiver 920 described with reference to FIG. 9. The transmitter 620 may utilize a single antenna or a set of antennas.

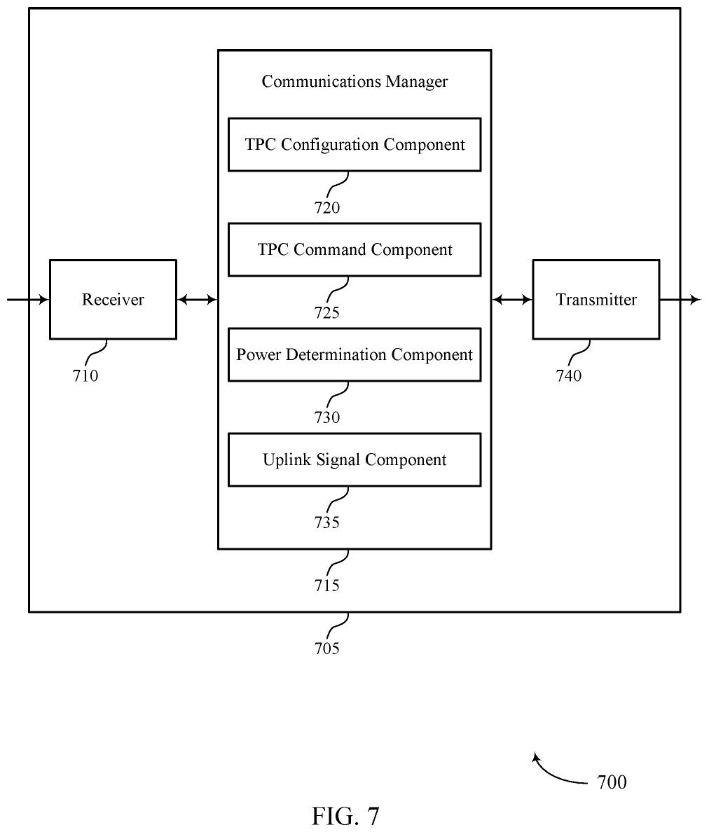

FIG. 7 shows a block diagram 700 of a device 705 that supports TPC indication for multi-panel transmission in accordance with aspects of the present disclosure. The device 705 may be an example of aspects of a device 605, or a UE 115 as described herein. The device 705 may include a receiver 710, a communications manager 715, and a transmitter 740. The device 705 may also include a processor. Each of these components may be in communication with one another (e.g., via one or more buses).

The receiver 710 may receive information such as packets, user data, or control information associated with various information channels (e.g., control channels, data channels, and information related to TPC indication for multi-panel transmission, etc.). Information may be passed on to other components of the device 705. The receiver 710 may be an example of aspects of the transceiver 920 described with reference to FIG. 9. The receiver 710 may utilize a single antenna or a set of antennas.

The communications manager 715 may be an example of aspects of the communications manager 615 as described herein. The communications manager 715 may include a TPC configuration component 720, a TPC command component 725, a power determination component 730, and an uplink signal component 735. The communications manager 715 may be an example of aspects of the communications manager 910 described herein.

The TPC configuration component 720 may receive, from a base station, an indication of a configuration for a multi-panel transmission power control command to be transmitted by the base station.

The TPC command component 725 may receive, according to the indicated configuration, a DCI message including a set of transmission power control commands.

The power determination component 730 may determine, based on the set of transmission power control commands, a first transmit power for a first antenna panel of the UE and a second transmit power for a second antenna panel of the UE.

The uplink signal component 735 may transmit an uplink signal using the first antenna panel at the first transmit power and the second antenna panel at the second transmit power.

The transmitter 740 may transmit signals generated by other components of the device 705. In some examples, the transmitter 740 may be collocated with a receiver 710 in a transceiver module. For example, the transmitter 740 may be an example of aspects of the transceiver 920 described with reference to FIG. 9. The transmitter 740 may utilize a single antenna or a set of antennas.

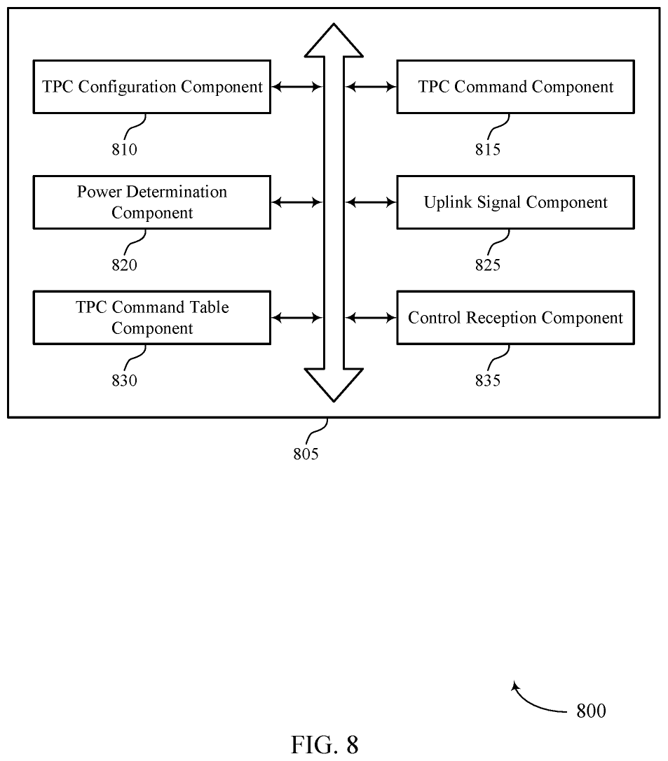

FIG. 8 shows a block diagram 800 of a communications manager 805 that supports TPC indication for multi-panel transmission in accordance with aspects of the present disclosure. The communications manager 805 may be an example of aspects of a communications manager 615, a communications manager 715, or a communications manager 910 described herein. The communications manager 805 may include a TPC configuration component 810, a TPC command component 815, a power determination component 820, an uplink signal component 825, a TPC command table component 830, and a control reception component 835. Each of these modules may communicate, directly or indirectly, with one another (e.g., via one or more buses).

The TPC configuration component 810 may receive, from a base station, an indication of a configuration for a multi-panel transmission power control command to be transmitted by the base station.

In some examples, determining, based on the received indication, that the configuration for the multi-panel transmission power control command indicates that the DCI message includes a first transmission power control command and a second transmission power control command, where the first transmission power control command is different from the second transmission power control command.

In some examples, determining, based on the received indication, that the configuration for the multi-panel transmission power control command indicates that the DCI message includes a first transmission power control command and a second transmission power control command, where the first transmission power control command is a same value as the second transmission power control command.

The TPC command component 815 may receive, according to the indicated configuration, a DCI message including a set of transmission power control commands.

In some cases, the first transmission power control command includes two bits the second transmission power control command includes one bit.

The power determination component 820 may determine, based on the set of transmission power control commands, a first transmit power for a first antenna panel of the UE and a second transmit power for a second antenna panel of the UE.

In some examples, the power determination component 820 may determine the first transmit power based on the first transmission power control command.

In some examples, the power determination component 820 may determine the second transmit power based on a second transmission power control command, where the second transmission power control value is a differential value applied to the first transmission power control command.

The uplink signal component 825 may transmit an uplink signal using the first antenna panel at the first transmit power and the second antenna panel at the second transmit power.

The TPC command table component 830 may determine, based on a first field of the DCI message, a table of one or more multi-panel transmission power control command tables.

In some examples, the TPC command table component 830 may determine the first transmission power control command and the second transmission power control command based on the table and a second field of the DCI message that indicates a corresponding entry of a set of entries of the table.

In some examples, the TPC command table component 830 may determine the one or more multi-panel transmission power control command tables based on a pre-configuration.

In some cases, the second field of the DCI message indicates a row of the table, where the row includes an indication of the first transmission power control command and the second transmission power control command.

The control reception component 835 may receive RRC signaling configuring the one or more multi-panel transmission power control command tables.

In some examples, the control reception component 835 may receive, from the base station, RRC signaling or a MAC-CE including the indication of the configuration.

In some cases, the DCI message includes the indication of the configuration.

FIG. 9 shows a diagram of a system 900 including a device 905 that supports TPC indication for multi-panel transmission in accordance with aspects of the present disclosure. The device 905 may be an example of or include the components of device 605, device 705, or a UE 115 as described herein. The device 905 may include components for bi-directional voice and data communications including components for transmitting and receiving communications, including a communications manager 910, an I/O controller 915, a transceiver 920, an antenna 925, memory 930, and a processor 940. These components may be in electronic communication via one or more buses (e.g., bus 945).

The communications manager 910 may receive, from a base station, an indication of a configuration for a multi-panel transmission power control command to be transmitted by the base station, receive, according to the indicated configuration, a DCI message including a set of transmission power control commands, determine, based on the set of transmission power control commands, a first transmit power for a first antenna panel of the UE and a second transmit power for a second antenna panel of the UE, and transmit an uplink signal using the first antenna panel at the first transmit power and the second antenna panel at the second transmit power.

The I/O controller 915 may manage input and output signals for the device 905. The I/O controller 915 may also manage peripherals not integrated into the device 905. In some cases, the I/O controller 915 may represent a physical connection or port to an external peripheral. In some cases, the I/O controller 915 may utilize an operating system such as iOS®, ANDROID®, MS-DOS®, MS-WINDOWS®, OS/2®, UNIX®, LINUX®, or another known operating system. In other cases, the I/O controller 915 may represent or interact with a modem, a keyboard, a mouse, a touchscreen, or a similar device. In some cases, the I/O controller 915 may be implemented as part of a processor. In some cases, a user may interact with the device 905 via the I/O controller 915 or via hardware components controlled by the I/O controller 915.

The transceiver 920 may communicate bi-directionally, via one or more antennas, wired, or wireless links as described above. For example, the transceiver 920 may represent a wireless transceiver and may communicate bi-directionally with another wireless transceiver. The transceiver 920 may also include a modem to modulate the packets and provide the modulated packets to the antennas for transmission, and to demodulate packets received from the antennas.

In some cases, the wireless device may include a single antenna 925. However, in some cases the device may have more than one antenna 925, which may be capable of concurrently transmitting or receiving multiple wireless transmissions.

The memory 930 may include RAM and ROM. The memory 930 may store computer-readable, computer-executable code 935 including instructions that, when executed, cause the processor to perform various functions described herein. In some cases, the memory 930 may contain, among other things, a basic I/O system (BIOS) which may control basic hardware or software operation such as the interaction with peripheral components or devices.

The processor 940 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 940 may be configured to operate a memory array using a memory controller. In other cases, a memory controller may be integrated into the processor 940. The processor 940 may be configured to execute computer-readable instructions stored in a memory (e.g., the memory 930) to cause the device 905 to perform various functions (e.g., functions or tasks supporting TPC indication for multi-panel transmission).

The code 935 may include instructions to implement aspects of the present disclosure, including instructions to support wireless communications. The code 935 may be stored in a non-transitory computer-readable medium such as system memory or other type of memory. In some cases, the code 935 may not be directly executable by the processor 940 but may cause a computer (e.g., when compiled and executed) to perform functions described herein.

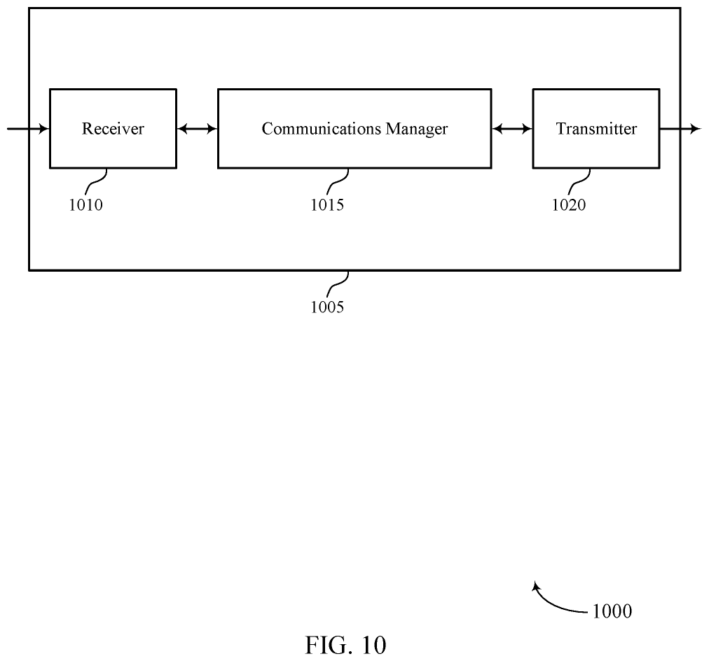

FIG. 10 shows a block diagram 1000 of a device 1005 that supports TPC indication for multi-panel transmission in accordance with aspects of the present disclosure. The device 1005 may be an example of aspects of a base station 105 as described herein. The device 1005 may include a receiver 1010, a communications manager 1015, and a transmitter 1020. The device 1005 may also include a processor. Each of these components may be in communication with one another (e.g., via one or more buses).

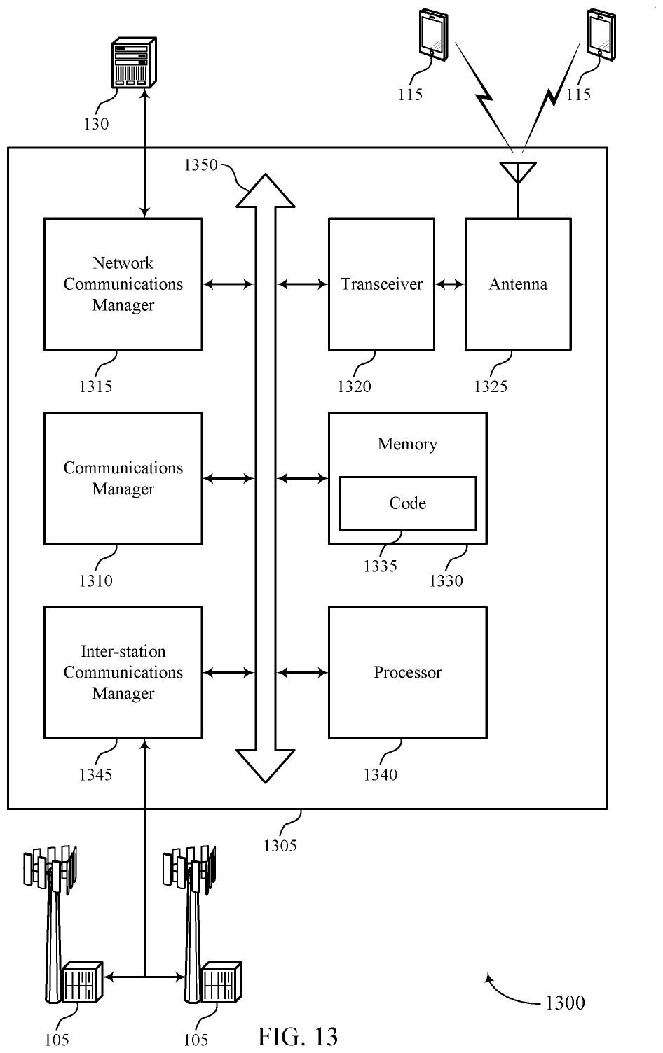

The receiver 1010 may receive information such as packets, user data, or control information associated with various information channels (e.g., control channels, data channels, and information related to TPC indication for multi-panel transmission, etc.). Information may be passed on to other components of the device 1005. The receiver 1010 may be an example of aspects of the transceiver 1320 described with reference to FIG. 13. The receiver 1010 may utilize a single antenna or a set of antennas.

The communications manager 1015 may transmit, to a UE, an indication of a configuration for a multi-panel transmission power control command to be transmitted by the base station, determine to adjust a transmit power of one or more of a first antenna panel or a second antenna panel of the UE served by the base station, and transmit, according to the indicated configuration, a DCI message including a set of transmission power control commands that are based on the determined transmit power. The communications manager 1015 may be an example of aspects of the communications manager 1310 described herein.

The communications manager 1015, or its sub-components, may be implemented in hardware, code (e.g., software or firmware) executed by a processor, or any combination thereof. If implemented in code executed by a processor, the functions of the communications manager 1015, or its sub-components may be executed by a general-purpose processor, a DSP, an application-specific integrated circuit (ASIC), a FPGA or other programmable logic device, discrete gate or transistor logic, discrete hardware components, or any combination thereof designed to perform the functions described in the present disclosure.

The communications manager 1015, or its sub-components, may be physically located at various positions, including being distributed such that portions of functions are implemented at different physical locations by one or more physical components. In some examples, the communications manager 1015, or its sub-components, may be a separate and distinct component in accordance with various aspects of the present disclosure. In some examples, the communications manager 1015, or its sub-components, may be combined with one or more other hardware components, including but not limited to an input/output (I/O) component, a transceiver, a network server, another computing device, one or more other components described in the present disclosure, or a combination thereof in accordance with various aspects of the present disclosure.

The transmitter 1020 may transmit signals generated by other components of the device 1005. In some examples, the transmitter 1020 may be collocated with a receiver 1010 in a transceiver module. For example, the transmitter 1020 may be an example of aspects of the transceiver 1320 described with reference to FIG. 13. The transmitter 1020 may utilize a single antenna or a set of antennas.

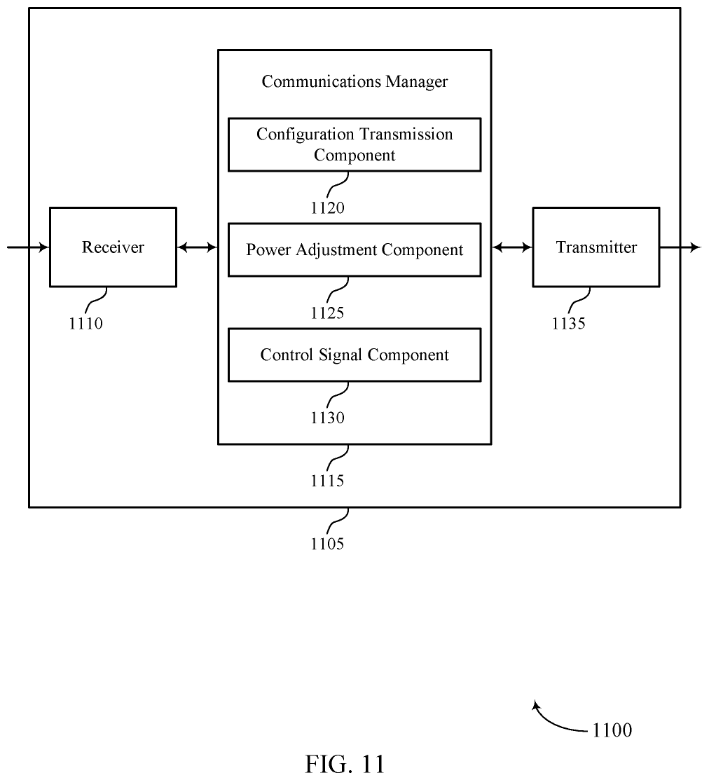

FIG. 11 shows a block diagram 1100 of a device 1105 that supports TPC indication for multi-panel transmission in accordance with aspects of the present disclosure. The device 1105 may be an example of aspects of a device 1005, or a base station 105 as described herein. The device 1105 may include a receiver 1110, a communications manager 1115, and a transmitter 1135. The device 1105 may also include a processor. Each of these components may be in communication with one another (e.g., via one or more buses).

The receiver 1110 may receive information such as packets, user data, or control information associated with various information channels (e.g., control channels, data channels, and information related to TPC indication for multi-panel transmission, etc.). Information may be passed on to other components of the device 1105. The receiver 1110 may be an example of aspects of the transceiver 1320 described with reference to FIG. 13. The receiver 1110 may utilize a single antenna or a set of antennas.

The communications manager 1115 may be an example of aspects of the communications manager 1015 as described herein. The communications manager 1115 may include a configuration transmission component 1120, a power adjustment component 1125, and a control signal component 1130. The communications manager 1115 may be an example of aspects of the communications manager 1310 described herein.

The configuration transmission component 1120 may transmit, to a UE, an indication of a configuration for a multi-panel transmission power control command to be transmitted by the base station.

The power adjustment component 1125 may determine to adjust a transmit power of one or more of a first antenna panel or a second antenna panel of the UE served by the base station.

The control signal component 1130 may transmit, according to the indicated configuration, a DCI message including a set of transmission power control commands that are based on the determined transmit power.

The transmitter 1135 may transmit signals generated by other components of the device 1105. In some examples, the transmitter 1135 may be collocated with a receiver 1110 in a transceiver module. For example, the transmitter 1135 may be an example of aspects of the transceiver 1320 described with reference to FIG. 13. The transmitter 1135 may utilize a single antenna or a set of antennas.

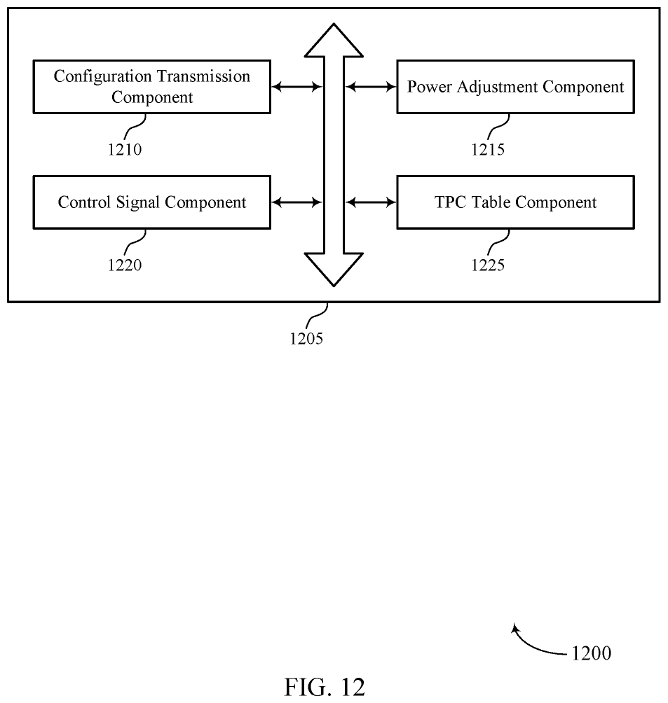

FIG. 12 shows a block diagram 1200 of a communications manager 1205 that supports TPC indication for multi-panel transmission in accordance with aspects of the present disclosure. The communications manager 1205 may be an example of aspects of a communications manager 1015, a communications manager 1115, or a communications manager 1310 described herein. The communications manager 1205 may include a configuration transmission component 1210, a power adjustment component 1215, a control signal component 1220, and a TPC table component 1225. Each of these modules may communicate, directly or indirectly, with one another (e.g., via one or more buses).

The configuration transmission component 1210 may transmit, to a UE, an indication of a configuration for a multi-panel transmission power control command to be transmitted by the base station.

In some examples, the configuration transmission component 1210 may transmit RRC signaling or MAC-CE signaling including the indication of the configuration.

In some cases, a first transmission power control command of the set of transmission power control commands is different from a second transmission power control command of the set of transmission power control commands, where the first transmission power control command is for the first antenna panel and the second transmission power control command is for the second antenna panel.

In some cases, the second transmission power control value is a differential value applied to the first transmission power control command.

In some cases, the first transmission power control command includes two bits the second transmission power control command includes one bit.

In some cases, the DCI message includes the indication of the configuration.

The power adjustment component 1215 may determine to adjust a transmit power of one or more of a first antenna panel or a second antenna panel of the UE served by the base station.

The control signal component 1220 may transmit, according to the indicated configuration, a DCI message including a set of transmission power control commands that are based on the determined transmit power.

The TPC table component 1225 may transmit, to the UE, RRC signaling configuring the one or more multi-panel transmission power control command tables.

In some cases, a first field of the DCI message indicates a table of one or more multi-panel transmission power control command tables and a second field of the DCI message indicates a corresponding entry of a set of entries of the table, the entry indicating a first transmission power control command and a second transmission power control command.

In some cases, the second field of the DCI message indicates a row of the table, where the row includes an indication of the first transmission power control command and the second transmission power control command.

FIG. 13 shows a diagram of a system 1300 including a device 1305 that supports TPC indication for multi-panel transmission in accordance with aspects of the present disclosure. The device 1305 may be an example of or include the components of device 1005, device 1105, or a base station 105 as described herein. The device 1305 may include components for bi-directional voice and data communications including components for transmitting and receiving communications, including a communications manager 1310, a network communications manager 1315, a transceiver 1320, an antenna 1325, memory 1330, a processor 1340, and an inter-station communications manager 1345. These components may be in electronic communication via one or more buses (e.g., bus 1350).

The communications manager 1310 may transmit, to a UE, an indication of a configuration for a multi-panel transmission power control command to be transmitted by the base station, determine to adjust a transmit power of one or more of a first antenna panel or a second antenna panel of the UE served by the base station, and transmit, according to the indicated configuration, a DCI message including a set of transmission power control commands that are based on the determined transmit power.

The network communications manager 1315 may manage communications with the core network (e.g., via one or more wired backhaul links). For example, the network communications manager 1315 may manage the transfer of data communications for client devices, such as one or more UEs 115.

The transceiver 1320 may communicate bi-directionally, via one or more antennas, wired, or wireless links as described above. For example, the transceiver 1320 may represent a wireless transceiver and may communicate bi-directionally with another wireless transceiver. The transceiver 1320 may also include a modem to modulate the packets and provide the modulated packets to the antennas for transmission, and to demodulate packets received from the antennas.

In some cases, the wireless device may include a single antenna 1325. However, in some cases the device may have more than one antenna 1325, which may be capable of concurrently transmitting or receiving multiple wireless transmissions.

The memory 1330 may include RAM, ROM, or a combination thereof. The memory 1330 may store computer-readable code 1335 including instructions that, when executed by a processor (e.g., the processor 1340) cause the device to perform various functions described herein. In some cases, the memory 1330 may contain, among other things, a BIOS which may control basic hardware or software operation such as the interaction with peripheral components or devices.

The processor 1340 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1340 may be configured to operate a memory array using a memory controller. In some cases, a memory controller may be integrated into processor 1340. The processor 1340 may be configured to execute computer-readable instructions stored in a memory (e.g., the memory 1330) to cause the device 1305 to perform various functions (e.g., functions or tasks supporting TPC indication for multi-panel transmission).

The inter-station communications manager 1345 may manage communications with other base station 105, and may include a controller or scheduler for controlling communications with UEs 115 in cooperation with other base stations 105. For example, the inter-station communications manager 1345 may coordinate scheduling for transmissions to UEs 115 for various interference mitigation techniques such as beamforming or joint transmission. In some examples, the inter-station communications manager 1345 may provide an X2 interface within an LTE/LTE-A wireless communication network technology to provide communication between base stations 105.

The code 1335 may include instructions to implement aspects of the present disclosure, including instructions to support wireless communications. The code 1335 may be stored in a non-transitory computer-readable medium such as system memory or other type of memory. In some cases, the code 1335 may not be directly executable by the processor 1340 but may cause a computer (e.g., when compiled and executed) to perform functions described herein.

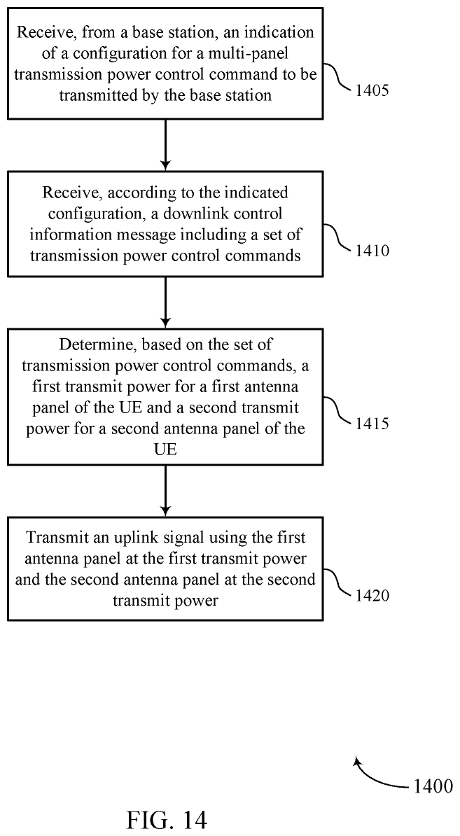

FIG. 14 shows a flowchart illustrating a method 1400 that supports TPC indication for multi-panel transmission in accordance with aspects of the present disclosure. The operations of method 1400 may be implemented by a UE 115 or its components as described herein. For example, the operations of method 1400 may be performed by a communications manager as described with reference to FIGS. 6 through 9. In some examples, a UE may execute a set of instructions to control the functional elements of the UE to perform the functions described below. Additionally or alternatively, a UE may perform aspects of the functions described below using special-purpose hardware.

At 1405, the UE may receive, from a base station, an indication of a configuration for a multi-panel transmission power control command to be transmitted by the base station. The operations of 1405 may be performed according to the methods described herein. In some examples, aspects of the operations of 1405 may be performed by a TPC configuration component as described with reference to FIGS. 6 through 9.

At 1410, the UE may receive, according to the indicated configuration, a DCI message including a set of transmission power control commands. The operations of 1410 may be performed according to the methods described herein. In some examples, aspects of the operations of 1410 may be performed by a TPC command component as described with reference to FIGS. 6 through 9.

At 1415, the UE may determine, based on the set of transmission power control commands, a first transmit power for a first antenna panel of the UE and a second transmit power for a second antenna panel of the UE. The operations of 1415 may be performed according to the methods described herein. In some examples, aspects of the operations of 1415 may be performed by a power determination component as described with reference to FIGS. 6 through 9.

At 1420, the UE may transmit an uplink signal using the first antenna panel at the first transmit power and the second antenna panel at the second transmit power. The operations of 1420 may be performed according to the methods described herein. In some examples, aspects of the operations of 1420 may be performed by an uplink signal component as described with reference to FIGS. 6 through 9.

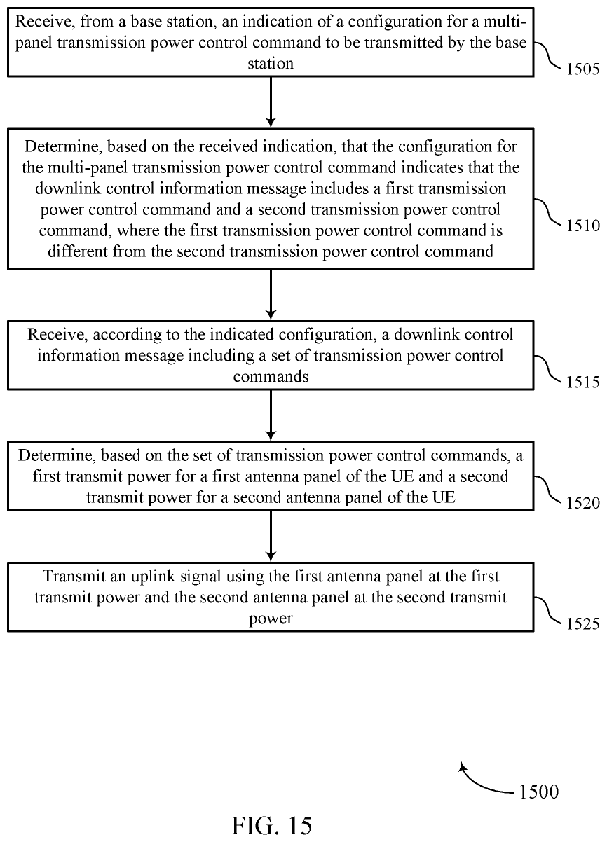

FIG. 15 shows a flowchart illustrating a method 1500 that supports TPC indication for multi-panel transmission in accordance with aspects of the present disclosure. The operations of method 1500 may be implemented by a UE 115 or its components as described herein. For example, the operations of method 1500 may be performed by a communications manager as described with reference to FIGS. 6 through 9. In some examples, a UE may execute a set of instructions to control the functional elements of the UE to perform the functions described below. Additionally or alternatively, a UE may perform aspects of the functions described below using special-purpose hardware.

At 1505, the UE may receive, from a base station, an indication of a configuration for a multi-panel transmission power control command to be transmitted by the base station. The operations of 1505 may be performed according to the methods described herein. In some examples, aspects of the operations of 1505 may be performed by a TPC configuration component as described with reference to FIGS. 6 through 9.

At 1510, the UE may determine, based on the received indication, that the configuration for the multi-panel transmission power control command indicates that the DCI message includes a first transmission power control command and a second transmission power control command, where the first transmission power control command is different from the second transmission power control command. The operations of 1510 may be performed according to the methods described herein. In some examples, aspects of the operations of 1510 may be performed by a TPC configuration component as described with reference to FIGS. 6 through 9.

At 1515, the UE may receive, according to the indicated configuration, a DCI message including a set of transmission power control commands. The operations of 1515 may be performed according to the methods described herein. In some examples, aspects of the operations of 1515 may be performed by a TPC command component as described with reference to FIGS. 6 through 9.

At 1520, the UE may determine, based on the set of transmission power control commands, a first transmit power for a first antenna panel of the UE and a second transmit power for a second antenna panel of the UE. The operations of 1520 may be performed according to the methods described herein. In some examples, aspects of the operations of 1520 may be performed by a power determination component as described with reference to FIGS. 6 through 9.

At 1525, the UE may transmit an uplink signal using the first antenna panel at the first transmit power and the second antenna panel at the second transmit power. The operations of 1525 may be performed according to the methods described herein. In some examples, aspects of the operations of 1525 may be performed by an uplink signal component as described with reference to FIGS. 6 through 9.

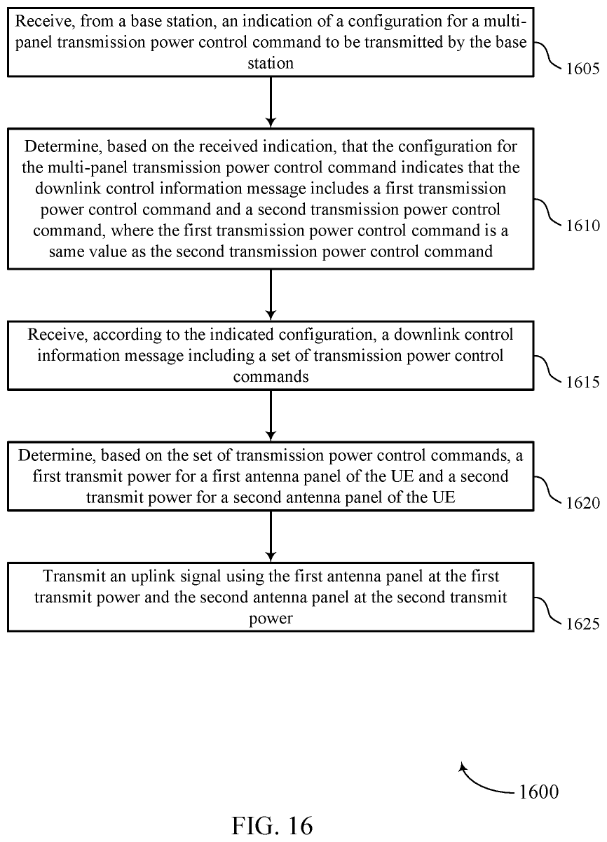

FIG. 16 shows a flowchart illustrating a method 1600 that supports TPC indication for multi-panel transmission in accordance with aspects of the present disclosure. The operations of method 1600 may be implemented by a UE 115 or its components as described herein. For example, the operations of method 1600 may be performed by a communications manager as described with reference to FIGS. 6 through 9. In some examples, a UE may execute a set of instructions to control the functional elements of the UE to perform the functions described below. Additionally or alternatively, a UE may perform aspects of the functions described below using special-purpose hardware.

At 1605, the UE may receive, from a base station, an indication of a configuration for a multi-panel transmission power control command to be transmitted by the base station. The operations of 1605 may be performed according to the methods described herein. In some examples, aspects of the operations of 1605 may be performed by a TPC configuration component as described with reference to FIGS. 6 through 9.

At 1610, the UE may determine, based on the received indication, that the configuration for the multi-panel transmission power control command indicates that the DCI message includes a first transmission power control command and a second transmission power control command, where the first transmission power control command is a same value as the second transmission power control command. The operations of 1610 may be performed according to the methods described herein. In some examples, aspects of the operations of 1610 may be performed by a TPC configuration component as described with reference to FIGS. 6 through 9.

At 1615, the UE may receive, according to the indicated configuration, a DCI message including a set of transmission power control commands. The operations of 1615 may be performed according to the methods described herein. In some examples, aspects of the operations of 1615 may be performed by a TPC command component as described with reference to FIGS. 6 through 9.

At 1620, the UE may determine, based on the set of transmission power control commands, a first transmit power for a first antenna panel of the UE and a second transmit power for a second antenna panel of the UE. The operations of 1620 may be performed according to the methods described herein. In some examples, aspects of the operations of 1620 may be performed by a power determination component as described with reference to FIGS. 6 through 9.

At 1625, the UE may transmit an uplink signal using the first antenna panel at the first transmit power and the second antenna panel at the second transmit power. The operations of 1625 may be performed according to the methods described herein. In some examples, aspects of the operations of 1625 may be performed by an uplink signal component as described with reference to FIGS. 6 through 9.

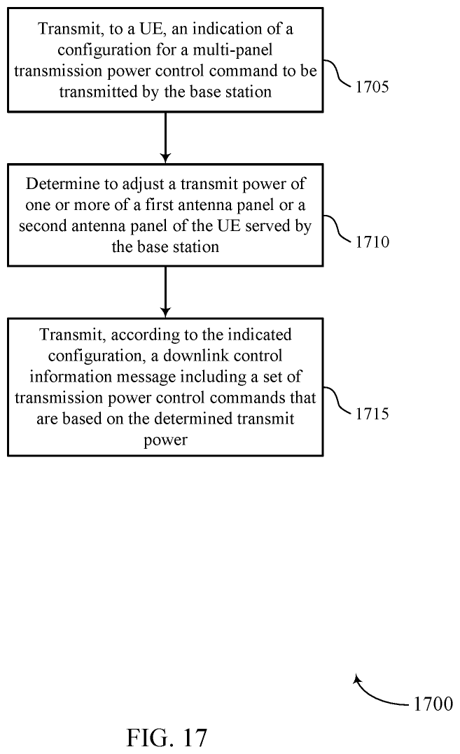

FIG. 17 shows a flowchart illustrating a method 1700 that supports TPC indication for multi-panel transmission in accordance with aspects of the present disclosure. The operations of method 1700 may be implemented by a base station 105 or its components as described herein. For example, the operations of method 1700 may be performed by a communications manager as described with reference to FIGS. 10 through 13. In some examples, a base station may execute a set of instructions to control the functional elements of the base station to perform the functions described below. Additionally or alternatively, a base station may perform aspects of the functions described below using special-purpose hardware.

At 1705, the base station may transmit, to a UE, an indication of a configuration for a multi-panel transmission power control command to be transmitted by the base station. The operations of 1705 may be performed according to the methods described herein. In some examples, aspects of the operations of 1705 may be performed by a configuration transmission component as described with reference to FIGS. 10 through 13.

At 1710, the base station may determine to adjust a transmit power of one or more of a first antenna panel or a second antenna panel of the UE served by the base station. The operations of 1710 may be performed according to the methods described herein. In some examples, aspects of the operations of 1710 may be performed by a power adjustment component as described with reference to FIGS. 10 through 13.

At 1715, the base station may transmit, according to the indicated configuration, a DCI message including a set of transmission power control commands that are based on the determined transmit power. The operations of 1715 may be performed according to the methods described herein. In some examples, aspects of the operations of 1715 may be performed by a control signal component as described with reference to FIGS. 10 through 13.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include random-access memory (RAM), read-only memory (ROM), electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

1. A method for wireless communications at a user equipment (UE), comprising:
receiving, from a base station, an indication of a configuration for a multi-panel transmission power control command to be transmitted by the base station;
receiving, according to the indicated configuration, a downlink control information message comprising a plurality of transmission power control commands;
determining, based at least in part on the plurality of transmission power control commands, a first transmit power for a first antenna panel of the UE and a second transmit power for a second antenna panel of the UE; and
transmitting an uplink signal using the first antenna panel at the first transmit power and the second antenna panel at the second transmit power.

2. The method of claim 1, further comprising:
determining, based at least in part on the received indication, that the configuration for the multi-panel transmission power control command indicates that the downlink control information message comprises a first transmission power control command and a second transmission power control command, wherein the first transmission power control command is different from the second transmission power control command.

3. The method of claim 2, further comprising:
determining the first transmit power based at least in part on the first transmission power control command; and
determining the second transmit power based at least in part on a second transmission power control command, wherein the second transmission power control command includes a differential value applied to the first transmission power control command.

4. The method of claim 3, wherein the first transmission power control command comprises two bits and the second transmission power control command comprises one bit.

5. The method of claim 1, further comprising:
determining, based at least in part on a first field of the downlink control information message, a table of one or more multi-panel transmission power control command tables; and
determining the first transmission power control command and the second transmission power control command based at least in part on the table and a second field of the downlink control information message that indicates a corresponding entry of a plurality of entries of the table.

6. The method of claim 5, wherein the second field of the downlink control information message indicates a row of the table, wherein the row comprises an indication of the first transmission power control command and the second transmission power control command.

7. The method of claim 5, further comprising:
receiving radio resource control signaling configuring the one or more multi-panel transmission power control command tables.

8. The method of claim 5, further comprising:
determining the one or more multi-panel transmission power control command tables based at least in part on a pre-configuration.

9. The method of claim 1, further comprising:
determining, based at least in part on the received indication, that the configuration for the multi-panel transmission power control command indicates that the downlink control information message comprises a first transmission power control command and a second transmission power control command, wherein the first transmission power control command is a same value as the second transmission power control command.

10. The method of claim 1, wherein receiving the configuration comprises:
receiving, from the base station, radio resource control signaling or a medium access control control element comprising the indication of the configuration.

11. The method of claim 1, wherein the downlink control information message comprises the indication of the configuration.

12. A method for wireless communications at a base station, comprising:
transmitting, to a user equipment (UE), an indication of a configuration for a multi-panel transmission power control command to be transmitted by the base station;
determining to adjust a transmit power of one or more of a first antenna panel or a second antenna panel of the UE served by the base station; and
transmitting, according to the indicated configuration, a downlink control information message comprising a plurality of transmission power control commands that are based at least in part on the determined transmit power.

13. The method of claim 12, wherein a first transmission power control command of the plurality of transmission power control commands is different from a second transmission power control command of the plurality of transmission power control commands, wherein the first transmission power control command is for the first antenna panel and the second transmission power control command is for the second antenna panel.

14. The method of claim 13, wherein the second transmission power control command includes a differential value applied to the first transmission power control command.

15. The method of claim 14, wherein the first transmission power control command comprises two bits and the second transmission power control command comprises one bit.

16. The method of claim 12, wherein a first field of the downlink control information message indicates a table of one or more multi-panel transmission power control command tables and a second field of the downlink control information message indicates a corresponding entry of a plurality of entries of the table, the corresponding entry indicating a first transmission power control command and a second transmission power control command.

17. The method of claim 16, wherein the second field of the downlink control information message indicates a row of the table, wherein the row comprises an indication of the first transmission power control command and the second transmission power control command.

18. The method of claim 16, further comprising:
transmitting, to the UE, radio resource control signaling configuring the one or more multi-panel transmission power control command tables.

19. The method of claim 12, further comprising:
transmitting radio resource control signaling or medium access control control element signaling comprising the indication of the configuration.

20. The method of claim 12, wherein the downlink control information message comprises the indication of the configuration.

21. An apparatus for wireless communications at a user equipment (UE), comprising:
a processor,
memory coupled with the processor; and
instructions stored in the memory and executable by the processor to cause the apparatus to:
receive, from a base station, an indication of a configuration for a multi-panel transmission power control command to be transmitted by the base station;
receive, according to the indicated configuration, a downlink control information message comprising a plurality of transmission power control commands;
determine, based at least in part on the plurality of transmission power control commands, a first transmit power for a first antenna panel of the UE and a second transmit power for a second antenna panel of the UE; and
transmit an uplink signal using the first antenna panel at the first transmit power and the second antenna panel at the second transmit power.

22. The apparatus of claim 21, wherein the instructions are further executable by the processor to cause the apparatus to:
determine, based at least in part on the received indication, that the configuration for the multi-panel transmission power control command indicates that the downlink control information message comprises a first transmission power control command and a second transmission power control command, wherein the first transmission power control command is different from the second transmission power control command.

23-28. (canceled)

29. The apparatus of claim 21, wherein the instructions are further executable by the processor to cause the apparatus to:
determine, based at least in part on the received indication, that the configuration for the multi-panel transmission power control command indicates that the downlink control information message comprises a first transmission power control command and a second transmission power control command, wherein the first transmission power control command is a same value as the second transmission power control command.

30. The apparatus of claim 21, wherein the instructions to receive the configuration are executable by the processor to cause the apparatus to:
receive, from the base station, radio resource control signaling or a medium access control control element comprising the indication of the configuration.

31. The apparatus of claim 21, wherein the downlink control information message comprises the indication of the configuration.

32. An apparatus for wireless communications at a base station, comprising:
a processor,
memory coupled with the processor; and
instructions stored in the memory and executable by the processor to cause the apparatus to:
transmit, to a user equipment (UE), an indication of a configuration for a multi-panel transmission power control command to be transmitted by the base station;
determine to adjust a transmit power of one or more of a first antenna panel or a second antenna panel of the UE served by the base station; and
transmit, according to the indicated configuration, a downlink control information message comprising a plurality of transmission power control commands that are based at least in part on the determined transmit power.

33. The apparatus of claim 32, wherein a first transmission power control command of the plurality of transmission power control commands is different from a second transmission power control command of the plurality of transmission power control commands, wherein the first transmission power control command is for the first antenna panel and the second transmission power control command is for the second antenna panel.

34-38. (canceled)

39. The apparatus of claim 32, wherein the instructions are further executable by the processor to cause the apparatus to:
transmit radio resource control signaling or medium access control control element signaling comprising the indication of the configuration.

40. The apparatus of claim 32, wherein the downlink control information message comprises the indication of the configuration.

41. An apparatus for wireless communications at a user equipment (UE), comprising:
means for receiving, from a base station, an indication of a configuration for a multi-panel transmission power control command to be transmitted by the base station;
means for receiving, according to the indicated configuration, a downlink control information message comprising a plurality of transmission power control commands;
means for determining, based at least in part on the plurality of transmission power control commands, a first transmit power for a first antenna panel of the UE and a second transmit power for a second antenna panel of the UE; and
means for transmitting an uplink signal using the first antenna panel at the first transmit power and the second antenna panel at the second transmit power.

42. The apparatus of claim 41, further comprising:
means for determining, based at least in part on the received indication, that the configuration for the multi-panel transmission power control command indicates that the downlink control information message comprises a first transmission power control command and a second transmission power control command, wherein the first transmission power control command is different from the second transmission power control command.

43-48. (canceled)

49. The apparatus of claim 41, further comprising:
means for determining, based at least in part on the received indication, that the configuration for the multi-panel transmission power control command indicates that the downlink control information message comprises a first transmission power control command and a second transmission power control command, wherein the first transmission power control command is a same value as the second transmission power control command.

50. The apparatus of claim 41, wherein the means for receiving the configuration comprises:
means for receiving, from the base station, radio resource control signaling or a medium access control control element comprising the indication of the configuration.

51. The apparatus of claim 41, wherein the downlink control information message comprises the indication of the configuration.

52. An apparatus for wireless communications at a base station, comprising:
means for transmitting, to a user equipment (UE), an indication of a configuration for a multi-panel transmission power control command to be transmitted by the base station;
means for determining to adjust a transmit power of one or more of a first antenna panel or a second antenna panel of the UE served by the base station; and
means for transmitting, according to the indicated configuration, a downlink control information message comprising a plurality of transmission power control commands that are based at least in part on the determined transmit power.

53-62. (canceled)
